(19) United States
(12) Patent Application Publication
(10) Pub. No.: US 2013/0132116 A1
(43) Pub. Date: May 23, 2013

(54) WIRELESS PATIENT DIAGNOSIS AND TREATMENT BASED SYSTEM FOR INTEGRATED HEALTHCARE ROUNDING LIST AND SUPERBILL MANAGEMENT

(71) Applicant: Sundaram Natarajan, Fremont, CA (US)

(72) Inventor: Sundaram Natarajan, Fremont, CA (US)

(21) Appl. No.: 13/302,683

(22) Filed: Nov. 22, 2011

(51) Int. Cl. G06Q 50/24

(52) U.S. Cl. 705/3

(57) ABSTRACT

A computerized client-server based comprehensive computerized method of health care administration that utilizes concepts from ICD codes, CPT codes, and superbills to both handle medical cost accounting, organize the activity of healthcare professionals, and improve communication of important aspects of the patient's medical record. The system is based on a wireless network client-server model in which healthcare professionals in all participating institutions and departments wirelessly communicate with a server using their respective handheld computerized devices such as smartphones and tablet computers. The software methods capture patient referral information, patient admission data, diagnosis, treatment, help organize the sign-off and rounding list process. The system also generates superbills, produces discharge reports, and ensures communication between all participating medical professionals.

### BACKGROUND OF THE INVENTION

1. Field of the Invention

This invention is in the field of computerized systems for patient healthcare management

2. Description of the Related Art

Review of ICD and CPT codes:

In the US and in many other countries as well, human diseases are classified according to the International Classification of Diseases (ICD) standard. This standard, which is published by the US Public Health service, is revised approximately once a decade, and is presently in transition from the ICD-9 standard to the ICD-10 standard. The ICD standard is particularly useful for providing a common way to index of hospital records and operations, and is intended to give a reasonable description of the clinical picture of a patient at any given moment in time.

Generally, for each diagnostic code, one or more medical procedures (e.g. medical services, surgical services, further diagnostic services such as lab tests) are also performed. These medical procedures are codified by the Current Procedural Terminology (CPT) codes, which are a semi-proprietary set of codes maintained by the American Medical Association. The CPT procedural codes are generally based on the underlying ICD diagnostic codes, and are generally revised once a year. There are CPT codes for evaluation and management, anesthesia, surgery, radiology, laboratory tests, and various drug and medical services, as well as codes for performance measurements and emerging technology.

In the US, use of both ICD and CPT codes for patient diagnosis, treatment, and reimbursement of services rendered is required by almost all health insurers including the Centers for Medicare & Medicaid Services (CMS) (e.g. Medicare) and also under the Health Insurance Portability and Accountability Act (HIPAA).

There are many thousands of ICD and CPT codes, far too many for healthcare professionals and clerical support staff to reliably memorize and use on a daily basis, and as a result, various computerized data entry and database systems use these codes to help manage various medical billing processes.

Review of Superbills:

Superbills, also called charge capture bills, are used by a healthcare provider (often a hospital or clinic) to document a patient's various diagnoses and treatment procedures for payment (typically insurance) purposes. Superbills typically are based on ICD and CPT codes, as well as Evaluation and Management (E&M) codes. Superbills typically have information pertaining to the rendering provider and the physician who is attending the patient, referred the patient, or who ordered the particular treatment for the patient. Superbills also have patient information (e.g. name, date of birth, insurance information, and the like), visit information (e.g. date or dates of the visit, various ICD and CPT codes associated with the visit, as well as other visit related information such as the times for time specific codes, units, drug quantity, authorization information, and the like.

Due to the complexity of managing the information required to assemble and process superbills, various computerized database systems have also been developed to generate, transmit, process and store superbills.

Review of Rounding Lists:

In hospital and clinic settings, typically any given patient will be treated by a team of healthcare providers. In hospital settings in particular, a patient who may be staying for many days will be managed by different healthcare providers, often with different specialties, who rotate in and out as their particular shifts begin and end. It is thus particularly important that patient care information be properly transmitted between these different shifts of different healthcare providers and different specialties. This process is often called the patient “sign-out” process, and the list of which healthcare professionals are responsible for various patients during certain times is often called the patient “rounding list”. As might be imagined, the process of information exchange during patient sign-outs and rounding list management is prone to errors and miscommunication, with subsequent poor patient outcomes, unless managed carefully.

As a result, there has been interest in developing computerized methods to manage such “rounding lists”. Prior articles in this field include Van Eaton et. al., “Organizing the transfer of patient care information: The development of a computerized resident sign-out system” Surgery (2004) July 136(1): 5-13; and Gurses and Xiao, “A Systematic Review of the Literature on Multidisciplinary Rounds to Design Information Technology”, Journal of the American Medical Informatics Association, 13(3) May/June 2006, 267-276. Other work includes Van Eaton et. al., U.S. patent application Ser. No. 11/166,434 (publication 2005/0288965).

Review of Patient Discharge Reports:

Often patients are under the care of a personal physician, who may begin a hospitalization stay or clinic visit by recommending that the patient visit a hospital, clinic, or other healthcare facility, where they will be administered by other healthcare professionals. Upon discharge from the hospital or healthcare facility, the hospital attending physician or other responsible healthcare professional will typically prepare a patient discharge report, which will usually be transmitted back to the patient's original personal physician, as well as to other healthcare professionals and/or insurance agencies as necessary. These discharge reports provide instructions and recommendations for subsequent patient care.

Typically patient discharge reports, such as hospital discharge summaries, are brief documents, often a page or less in length, that may include the main patient diagnoses, main surgeries or other procedures, relevant radiology or lab tests, list of key medical consultants involved, key complications, list of discharge medications or as needed medications, list of future recommended lab or radiology studies, and recommendations for future treatment. Other elements may include the patient's condition on discharge, reason for hospitalization, patient or patient's family instruction, and ideally the attending physician's signature.

Other work in the field includes Geisler, U.S. patent application Ser. No. 10/427,262, who teaches a “System and method for managing interactions between machine-generated and user-defined patient lists”; Martin et. al., U.S. patent application Ser. No. 12/247,987, who teaches “Generation and Dissemination of Automatically Pre-Populated Clinical Notes”; Walter et. al., U.S. patent application Ser. No. 10/300,229 who teaches a “Method and apparatus for wireless access to a health care information system”; and Green et. al., U.S. Pat. No. 7,716,072, who teaches an “Integrated medical software system”.

Green et. al., U.S. patent application Ser. No. 13/036,973, also teaches an “INTEGRATED MEDICAL SOFTWARE SYSTEM WITH EMBEDDED TRANSCRIPTION FUNCTIONALITY”; and in application Ser. No. 12/392,998 (non-publication request), teaches a SYSTEM AND METHOD FOR ANALYZING, COLLECTING AND TRACKING PATIENT DATA ACROSS A VAST PATIENT POPULATION.

Companies currently active in the field include MDTech, pMDsoft, MedAptus, Rounding List, and Ingenious Med. Scott and Delaney of MedAptus, in U.S. Pat. No. 7,685,002 teach a “Method and system for processing medical billing records”.

In spite of these and other advances, and in spite of advances in computer technology, exemplified by sophisticated handheld mobile wireless devices such as Smartphones, as well as and the widespread adoption of high speed networks and internet client-server technology, further advances in medical administration technology is needed. At present the process of managing patients is still extremely cumbersome, prone to error, and requires an excessive amount of time on the part of physicians and other healthcare professionals. Thus methods to streamline these various functions would improve patient care, reduce waste, and also help control ever escalating healthcare costs.

### BRIEF SUMMARY OF THE INVENTION

The invention is based, in part, on the insight that what busy healthcare practitioners need is a single application program or internet interface to a single application program, running on their mobile wireless network-connected handheld computerized devices, which would allow them to handle their many disparate healthcare management needs at once.

The invention is also based, in part, on the insight that although historically, there has been a general separation between the functions of healthcare cost accounting, healthcare practitioner staff allocation considerations, and patient medical records, if this historical separation is abandoned in favor of a more unified approach, considerable efficiencies could be gained.

The invention is also based in part, on the insight that modern medical cost accounting practices, in particular ICD codes and CPT codes, can be used for more than just cost accounting. The invention uses ICD and CPT based cost accounting systems to also help better organize communication between various healthcare practitioners, as well as conveniently transmit and retrieve at least key aspects of the patient medical records as well.

In one embodiment of the invention, an admitting physician at a hospital can use the invention to input information on a newly admitted patient into the physician's mobile wireless smartphone or wireless tablet computer. This information can include the physician's initial impression as to the patient's diagnostic status and immediate treatment needs. The invention, running in part as an app on the physician's smartphone, and part as software or scripts on a network server, can take this information and cross correlate this with the appropriate ICD and CPT codes, as well as keep track of this information for latter billing purposes.

The incoming physician may also use the same system to transfer this patient information to the institution's rounding list, where the patient will be assigned to the appropriate team of doctors, who can also access this information as well on their respective smartphones as they go on and off their various shifts.

The same system also allows the various hospital and clinic staff members to use their smartphones to update the patient's diagnostic and treatment status on an as-needed basis, and this information may then be seamlessly be passed on to other healthcare professionals according to the institution's rotation list.

When the patient is finally discharged, the discharge physician may use the same system on his or her smartphone to produce the final discharge report, send this report to the patient's regular physician, and also generate one or more superbills to send to the patient's insurance carrier.

The net result is a unified system that can both greatly streamline the patient reporting process, cut down on errors, and improve medical treatment generally.

### BRIEF DESCRIPTION OF THE DRAWINGS

FIG. 1 shows an overview of the invention operating in the context of the wider healthcare environment that includes referring primary care physicians, hospitals with admitting physicians and other staff, and third party insurers.

FIG. 2 shows some of the major software modules and databases within the invention's server, and how the invention's server communicates with various computerized mobile devices over at least one wireless network.

FIG. 3 shows an overview of some of the key functions performed by the invention, here called the “TruScripts Messaging System”.

FIG. 4 shows a higher level overview showing the interaction between a healthcare professional, the invention's software, and the CPT code database during a physician office visit.

FIG. 5 shows a detail of how the system assigns CPT codes during the patient admission process to a hospital.

FIG. 6 shows an example of the user interface that the invention may generate on a physician user's Smartphone touch sensitive display screen. Here a physician is entering in the appropriate CPT code for a short patient follow-up and discharge visit.

FIG. 7 shows a flow chart of some of the key steps involved in the invention's rounding list module.

FIG. 8 shows an example of a Smartphone showing an example of the user interface for a particular physician's daily rounding list.

FIG. 9 shows more details of the invention's rounding list module. This module can accept data from the hospital's database, or by data entry into a conventional web browser, generate rounding lists, send the rounding list to the relevant physician's smartphones (or other mobile computerized device). The module can also capture the ICD and CPT codes entered in by the various physician's as they attend to the patient, and integrate this information into the invention's superbill module as well.

FIG. 10 shows an example of the rounding list display screen, here presented in higher resolution form which can be displayed in the user interface of a web browser.

FIG. 11 shows an example of the superbill display screen, again presented in a higher resolution form which can be displayed in the user interface of a web browser.

FIG. 12 shows additional detail of how the superbill module can take the patient's ICD diagnosis code, link in additional diagnosis codes for the patient as needed (here a Gastroenterology diagnosis), and update and manage the corresponding patient superbill.

FIG. 13A shows a smartphone screenshot that allows the HCP, during the new patient admission process, to enter in the location where he or she is working.

FIG. 13B shows a smartphone screenshot that allows the HCP, during the new patient admission process, to tell the system if he or she is the attending physician or not.

FIG. 14A shows a screenshot for a returning hospital patient.

FIG. 14B shows a screenshot of the system selecting a returning patient, Jack O'Lantern.

FIG. 15A shows the admitting physician entering in the diagnostic reason for Jack's visit.

FIG. 15B shows the ICD codes associated with Jack's visit.

FIG. 16A shows the admitting physician selecting the initial treatment CPT code for the visit.

FIG. 16B shows a summary of Jack's initial enrollment data.

FIG. 17A shows the admitting physician informing the system who the name of Jack's referring physician (or primary care physician) is. The name of this referring physician is “Self”, and the admitting physician can also add other notes as appropriate. Here the name of the admitting physician is Scarlet O'Hara.

FIG. 17B shows that the physician or HCP can also use the device to enter in follow up notes in audio form, which can be used directly or transcribed and then used.

FIG. 18 shows that as the system continues to be used and various ICD code and CPT codes are entered, the system can periodically generate superbills. This superbill summarizes much of the information previously entered in by FIGS. 13a-17B.

FIG. 19A shows that the admitting physician has successfully transmitted this initial superbill to the appropriate administrative systems.

FIG. 19B shows that the admitting physician can also provide follow-up notes as needed.

FIG. 20A shows that towards the end of the hospital stay, the system can also generate a patient discharge report.

FIG. 20B shows a process of creating the discharge report.

FIG. 21A shows the original reason for admission on the discharge report.

FIG. 21B shows the interface by which the attending physician can order discharge medication for the patient.

FIG. 22A shows the first part of the discharge summary for the patient.

FIG. 22B shows the second part of the discharge summary for the patient.

FIG. 23 shows that this discharge summary has been successfully transmitted to the referring physician for subsequent follow up.

### DETAILED DESCRIPTION OF THE INVENTION

Definition: Throughout this specification, the term physician and healthcare professional (HCP) will be used interchangeably. Although all physicians are HCP, not all HCP are physicians. HCP generally comprise admitting physicians, attending physicians, referring physicians, primary care physicians, emergency room physicians, nurses, therapists and other authorized individuals.

Although for purposes of illustrations only two sites—a physician's office, and a hospital will be used to illustrate the invention, in practice the invention may be used in a wide variety of medical settings, such as clinics, ambulances, nursing homes, other emergency facilities, group practices and the like. Thus the use of the term “hospital” in some of the examples is not intended to be limiting.

In one embodiment, the invention may be a comprehensive computerized method of health care administration, often performed with the aid of mobile wireless handheld computerized devices such as smartphones, tablet computers, and the like, which will often communicate wirelessly to other computerized devices such as internet servers that in turn manage medical databases. A variety of different health care professionals (HCP), often affiliated with hospitals and clinics, can use the system to both electronically document the fees associated with a plurality of medical treatments performed on their patients, and also simultaniously manage the medical treatment of these patients.

The invention's system and methods comprise software methods which are particularly useful when the responsibility for the care of the patients (often many patients) are shared among various healthcare professionals, such as the healthcare professionals that work in one or more healthcare facilities (e.g. hospitals, clinics), each with their own unique facility identifiers.

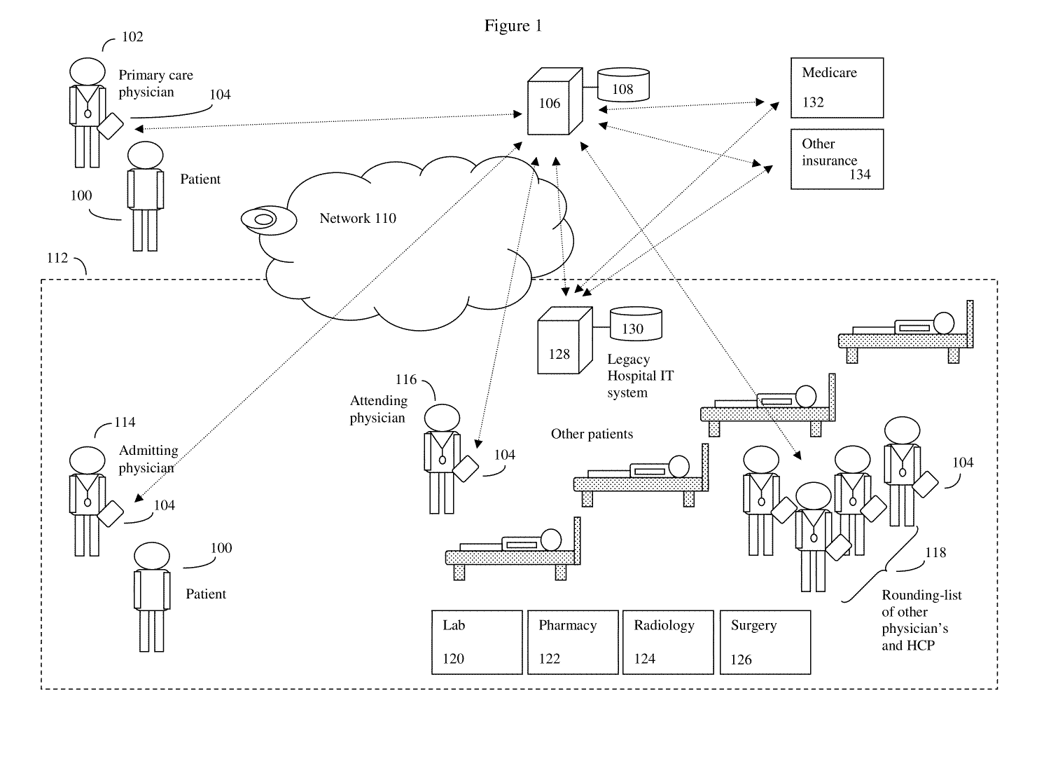

FIG. 1 shows an overview of the invention operating in the context of the wider healthcare environment that includes referring primary care physicians, hospitals with admitting physicians and other staff, and third party insurers.

In this scenario, a patient (100) has met with his or her primary care physician (102), for example in the physician's office. The physician has referred the patient to the local hospital (112) for diagnosis and treatment. Primary care physician (102) carries a smartphone or other wireless network connected computerized device (104), which maintains a wireless network connection with the invention's server (106) (e.g. internet web server) and database (108). The network (110) will often consist, at least in part, of the internet supplemented as appropriate by various cellular phone networks, and local networks. Here the network cloud should be considered to be connecting all wireless computerized devices, but to make the drawing easier to read, the extent of the cloud (110) has been limited to allow other aspects of the system and environment to be seen better.

In hospital (112), the same patient (100) may now meet with an admitting physician or other healthcare professional (114), who is also carrying a mobile wireless network connected computerized device, such as a smartphone or tablet computer, similar to device (104). The admitting physician (114) will use the invention's system and method to take in basic information about the patient, establish insurance information, and often enter in the initial ICD diagnosis codes. This information can be transmitted to the invention's server and database (106), (108).

Once the patient (100) is checked in to the hospital (112), the patient may be seen by other physicians or healthcare professionals such as the attending physician (116), and other physicians and healthcare professionals (118) as determined by their respective rounding schedules. Each of these may also be communicating with the invention's server and database (106), (108) via their own wireless network connected computerized devices similar to (104). While in the hospital, these various healthcare professionals will be making additional diagnoses (ICD codes) and also performing various treatment procedures and services (CPT codes) such as, for example, various lab services (120), drugs from the pharmacy (122), various radiology scans (124) and various surgical procedures (126). Using their wireless network computerized devices (104), and the invention's server (e.g. inventions methods and server software) and database (106), (108), as these ICD codes and CPT codes are entered, the system captures this information, updates the superbill information, and relays the information and associated notes to other healthcare professionals (118) as per their rounding list schedules.

The invention can also update the legacy hospital IT system (128) and database (130) (e.g. the hospital accounting system, the hospital medical records system), and also send superbill information (either directly or via the hospital IT system) to various insurance providers such as Medicare (132) and other insurers (134).

The wireless network computerized devices (104) can be standard devices such as smartphones, and tablet computers, as well as portable computers, and desktop computers. Generally use of smartphones and tablet computers are preferred because these can be carried by the healthcare professional at all times. Such devices, exemplified by the popular Apple iOS and Android operating system smartphones such as the iPhone, iPad, iPod, and the like typically have at least one computer processor (e.g. microprocessor), often a derivative of the popular ARM, x86, or MIPS family of processors. The devices often have memory (typically 1 gigabyte or more), touch sensitive display screens, and wireless network connections such as WiFi connectivity, cellular network (e.g. 3G or 4G) connectivity, and usually touch sensitive high resolution display screens.

The invention's servers (106) can also be standard devices, such as typical Internet web servers. Such servers often themselves contain at least one computer processor (e.g. microprocessor), typically 1 gigabyte of more of memory, and often run under a Windows, Linux, or Unix operating system. The invention's databases (108) can run on conventional mass storage devices such as hard drives and solid state drives, and the databases can be accessed by the invention's software by making appropriate calls to standard database software such as MySQL and the like.

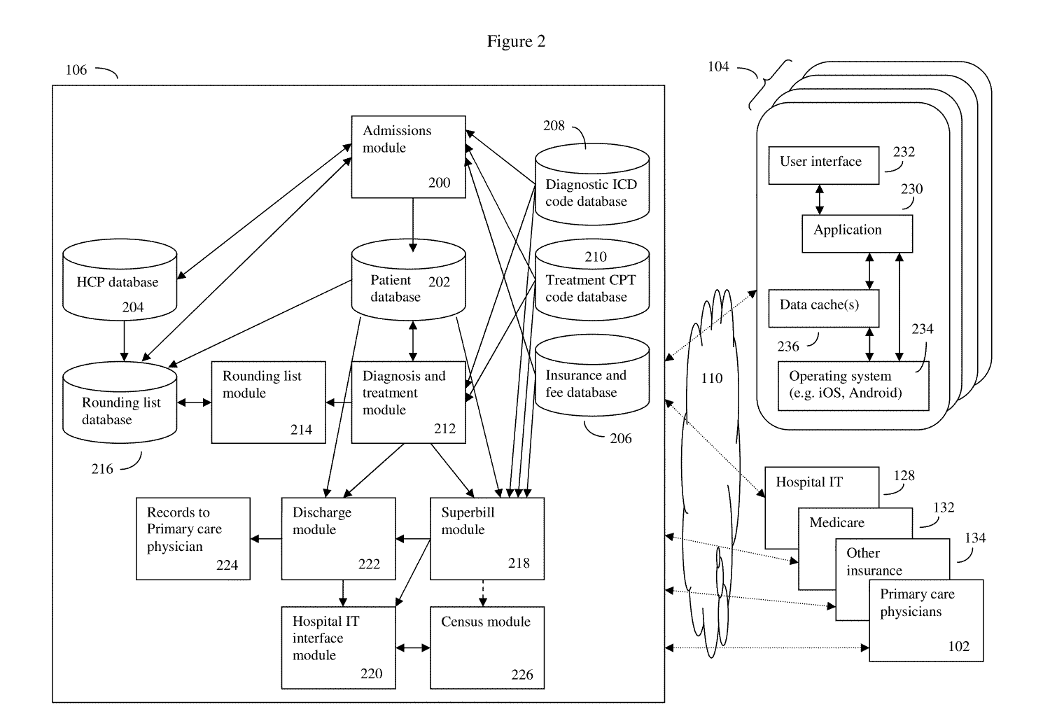

The invention's various methods will be implemented by software that runs in part on the server (106), and in part on the various wireless network computerized devices (104). This is shown in more detail in FIG. 2.

Here for example, when the patient (100) is first seen by the admitting physician (114), the admitting physician can use his wireless device (104) to interact with the admissions software module (200) running on server (106). The admitting physician (or other health care professional) can enter in the patient's identification information, as well as the institution identification information (e.g. that the patient is being treated at hospital 112), and enroll the patient in the system's patient database (202). The admitting physician can also identify himself or herself using information obtained from the system's healthcare professional (HCP) database (204), as well as draw on HCP database (204) to forward patient information as relevant. The admitting physician (114) can also enter in insurance information via insurance database (206), and also enter in at least the initial diagnosis information, ICD codes, and possibly even the initial treatment, CPT codes, using the ICD code database (208) and CPT code database (210).

In some embodiments, once the patient (100) has been admitted by the admitting physician (114), the system can also generate an admit summary, and send this admit summary (often along with the corresponding superbill) to the referring physician (102). This function can also be done directly from the application (app) running on device(s) (104). As per the discharge summary (to be discussed), the admit and discharge summaries can be triggered using codes that denote the type of visit.

Generally, once the patient (100) is admitted, other healthcare professionals such as the attending physician(s) (116) and consulting physicians (not shown) will perform additional diagnosis and treatment on the patient, as well as be sure that the patient is properly placed on the rounding list schedules and databases of the various staff physicians and HCP (118). According to the invention, these processes can be performed using the methods implemented by the diagnosis and treatment module (212), the rounding list module (214), which can update the HCP rounding list database (216), and draw upon HCP information in the HCP database (204) to do so. This process of updating via the diagnosis and treatment module (212) and updating the rounding list via the rounding list module (214) can continue for the duration of the patient's hospital stay.

In some embodiments, the rounding list module (214) can also implement “cover for a doctor” functionality. This is an automated process through which a doctor can request cover or backup by another doctor and the rounding lists are automatically shared on the dates when the backup is required.

As dictated by institutional policy, the information generated by the diagnosis and treatment module (212), as supplemented by the ICD codes from the diagnostic ICD code database (208), the treatment CPT code database (210), and the insurance and fee database (206) can be transmitted to the superbill module (218). Thus for longer duration hospital stays, multiple superbills may be generated. The superbill data from the superbill module (218) can as needed be transmitted to the legacy hospital information technology (IT) system (128) by way of the hospital IT interface module (220) and appropriate network connections.

Once the patient is ready for discharge from hospital (106), the appropriate attending physician (116) or other staff HCP (118) can enter in the appropriate discharge information using discharge module (222), again drawing on information from the other modules and databases as appropriate, and this discharge information can be transmitted using the record transmission module (224) back to, for example, the original primary care physician (102) who referred patient (100) in the first place. This scheme can greatly improve the care of patient (100), because the patient's primary care physician (102) now knows exactly what went on in hospital (106), and what the hospital staff recommendations are with regards to follow up care on patient (100).

Thus the net effect of the invention is to leverage off of the ICD/CPT code and superbill infrastructure, and in effect use this infrastructure to facilitate communication between the various HCP (e.g. primary care physician 102, admitting physician 114, attending physician(s) 116, and staff physicians 118) leading to improved patient care and better outcomes. In effect the system streamlines the patient medical records system, the HCP rounding list system, and the superbill creation and management process.

The invention may also take various statistical data from the various databases (202, 204, 206, 208, 210, and 216), process this data according to a census module (226) and present this data to, for example, the hospital accountants and administrators as well as insurance and regulatory personnel for evaluation purposes.

The invention's server(s) (106) will usually communicate to at least a plurality of different mobile wireless network computerized devices (104), often smartphones and wireless tablet computers, as well as other types of computers (e.g. desktop computers, laptop computers) via other wired or wireless network connections. The invention's applications or “app” software (230) running on these devices (104) will establish a network connection with the various software modules and databases running on server (106), and using the device's user interface (232) and operating system (234), as well as the device's processor(s), memory, and usually touch sensitive display screen (not shown) allow users such as physician/HCP (102), (114), (116), (118) interact with the system. To facilitate interactivity, information needed to generate various screens/forms, as well as frequently used information (e.g. commonly used ICD and CPT codes, most commonly used HCP, and the like) may be stored onboard one or more data caches (236), updated from server (106) as needed.

For simplicity, all of the various FIG. 2 databases (204, 206, 208, 210, and 216) are symbolized on FIG. 1 as database (108). Data cache (236) can also draw on any of these databases as needed.

Although in some embodiments, the invention's system and method(s) could in principle eventually become the main control mechanism behind a next-generation improved patient medical records and rounding list management, in other embodiments, the invention will be used as a supplement for the legacy patient medical records system and/or rounding list management system. Here for example, the invention can be used to quickly send top-level summary results, with the legacy systems being used to communicate a more extensive amount of information, albeit in a possibly slower and less convenient manner.

Thus put alternatively, often, the invention's method will be based on a computerized healthcare professional database (HCP database 204) which keeps a record of the various HCP working with the system. This HCP database, for example, will often comprise the names of the HCP, along with their rounding schedules (e.g. when and where the HCP is on duty), and the names or identifiers of the patients assigned to the HCP during his or her rounding schedules. The invention's method will also be based on a patient database of the various patients (202), which will generally also have links the various patient's medical records.

The invention will further provide an ICD database of a plurality of diagnostic ICD codes (218), a CPT database of a plurality of medical treatment CPT codes (210); and a fee database based on these diagnostic ICD codes, medical treatment CPT codes, and the patient's medical insurance status (206).

Based on this information, the invention will provide software, often configured to run on wireless handheld computerized devices (104), such as smartphones, and which may be uploaded from one or more servers (106) over a wireless connection, which will allow healthcare professionals (e.g. 102, 114, 116, 118) to input information to electronically admit a patient (100) to a health care facility (112). Thus for example the software (e.g. modules 200, 212, 214, 218, 222, 224, 220) may provide one or more electronic forms, often running on a web browser, that enable the healthcare professional to input the type of health care facility, the referring HCP, and the patient diagnostic status.

Once admitted, the invention's software methods will allow both the admitting healthcare professional (114), and other relevant healthcare professional (116, 118), on an as needed basis to further input updates on the patient's diagnostic status. This can be done, for example, by providing electronic forms (often provided by diagnosis and treatment module 212) to enable relevant healthcare professionals to repeatedly input the patient's diagnostic status, and use the system's ICD database (208) to generate a diagnostic ICD code matching the patient's diagnostic status, and/or input a treatement for the patient, and use the system's CPT database (210) to generate a matching medical treatment CPT code matching this patient treatment.

As previously discussed, the system will also use this HCP database (204), and the HCP rounding schedules of said HCP (216) to either automatically (often using the rounding list module 214) assign the patient to one more HCP (118) during these rounding schedules and automatically exchange information relating to the patient, or alternatively allow the authorized HCP to input data that overrides this rounding schedule based automatic assignment and automatic exchange of information, and provide an alternate assignment and alternate exchange this patient information with other individuals (e.g. HCP not on the rounding schedule, authorized administrators, and the like).

The system will also automatically use its fee database (206), in conjunction with the patient's diagnostic ICD code(s), medical treatment CPT code(s), the health care facility identifier, and the patien't medical insurance status to either generate at least one patient superbill (usually using superbill module 218), or alternatively allow the user to input data determining when to automatically generate this at least one patient superbill.

Further when the time comes for the patient to be discharged from the health care location, the system (usually using discharge module 222) will allow the relevant HCP to input data to electronically transmit a patient discharge report (using module 224) to the original referring HCP (e.g. the patient's normal physician 102). To do all this, the patient database (202), HCP database (204), ICD database (208), CPT database (210), and fee database (206) will typically be stored on at least one server (106) with wired or wireless network connectivity.

As previously discussed, this method will most commonly be implemented using input derived from the user interface (232) provided by an application (230) running on a handheld computerized device (104), often a mobile wireless handheld computerized device such as a smartphone or wireless tablet computer. This device (104) will typically have wireless network connectivity and a touch screen interface. This input can often be used to annotate or create the patient's medical records as well.

In addition to keystrokes and character data that the various users may input on device (104), such devices often are equipped with sound and even video recording capability as well. In some embodiments, the system can enable the users to generate one or more audio or even video files transcripts of audio input using said handheld computerized device (104), and use this data to further annotating the patient medical records with said these audio files or transcripts of audio input. This data in turn can be transmitted to the various HCP (e.g. 118, 102, 116) to their rounding schedules or other routing criteria.

As previously discussed, in order to improve the response time of the system, often it will be convenient to store a copy of portions of relevant databases, such as the patient database (202), HCP database (204), ICD database (208), CPT database (210) and the fee database (210) reside in the memory (e.g. cache 236) of the handheld computerized device (104). These copies can be periodically updated from the invention's server (106) over network (110) as needed.

Alternatively server (106) may also serve web pages, and allow users to access the various modules and databases via conventional web browsers running on computers by way of either a wired, optical, or wireless internet network connection.

Generally, the superbills created by the system's superbill module (218) will often contain information such as the provider information, physician information, patient information, visit information, the relevant diagnostic ICD codes, the relevant medical treatment CPT codes, date of service, time of service location, units of service, and drug quantity and other information as desired.

In some embodiments in addition to sending discharge reports to the patient's referring physician/HCP or primary care physician/HCP (102) at the time of discharge, the system may also electronically transmitting a patient admission summary report to the referring HCP (102) at time of patient admission. Additional progress reports can also be transmitted according to a schedule designated by the admitting or primary care physician (102).

Generally, the discharge summary generated by discharge module (222) may a record of the main diagnoses, surgeries or procedures, diagnostic tests, consultant lists, and summary of complications encountered during the patients hospital (or clinic) stay. Other items that often may be transmitted as well will include a list of medications on discharge, list of pending lab tests, a list of recommended tests, patient condition on discharge, patient instructions, and physician instructions.

The rounding list information generated by rounding list module (214) in conjunction with the HCP database (204) and the rounding list database (216) will generally be a list of patients assigned to the hospital's (or clinic's) HCP during at least the HCP's current rounding list shift. Other information will often also include the location of the patient (e.g. room number), and the patient diagnostic status, at least as defined by the ICD codes. Often it will be useful to link this rounding list to at least portions of the patient's medical records, and when used this way, the system's rounding list module can usefully serve as a convenient to index to allow the HCP to retrieve more information pertaining to the patient's medical history. In this way the system serves to augment the existing medical records system by providing a convenient index to the patient's more detailed medical records. In principle, if the complete copy of the patient's medical records were put on the patient database (202) or other database, then the invention ultimately might be able to replace legacy medical record systems and rounding list systems altogether.

As previously discussed, the invention's census module (226) may be used to generate overall institutional census reports (e.g. for hospital 112) with summary statistics and/or charts showing overall utilization of this health care facility during a selected period of time.

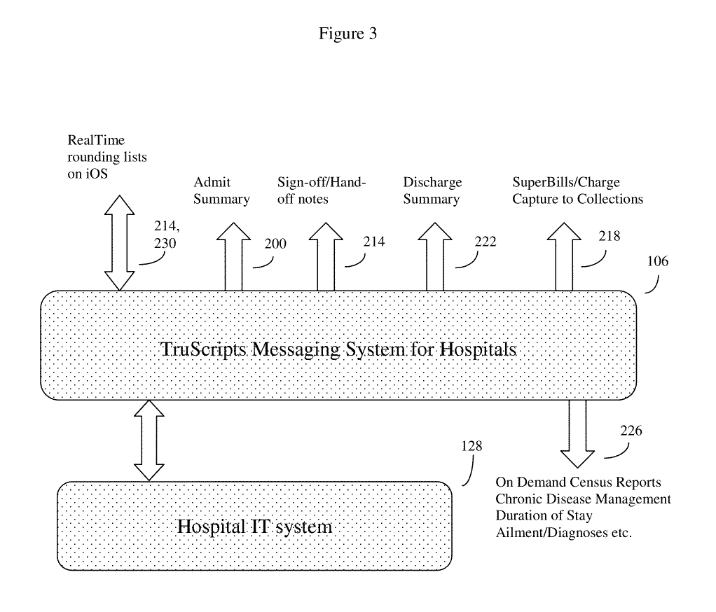

FIG. 3 shows a simplified overview of some of the key functions performed by the invention, here called the “TruScripts Messaging System”.

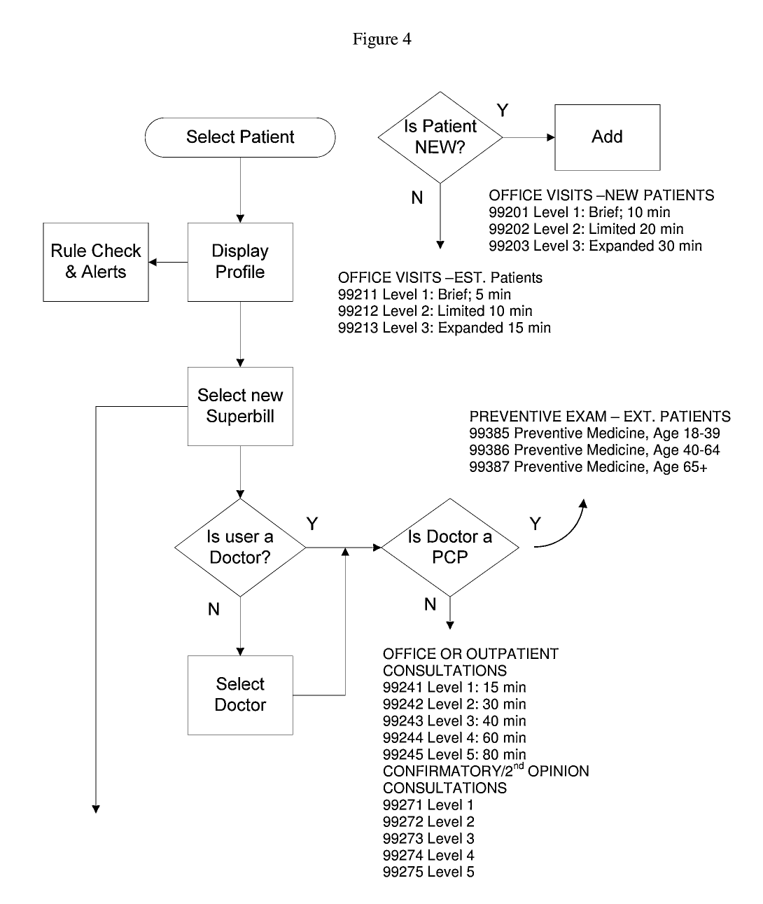

FIG. 4 shows a higher level overview showing the interaction between a healthcare professional, the invention's software, and the CPT code database during a physician office visit. These steps can be implemented by modules such as the admissions module (200) and the diagnosis and treatment module (212). Note that this module and other module function by a combination of procedures that call for user input, search the various databases such as the CPT database (210) for codes that match the appropriate data, and follow rules appropriate for that situation.

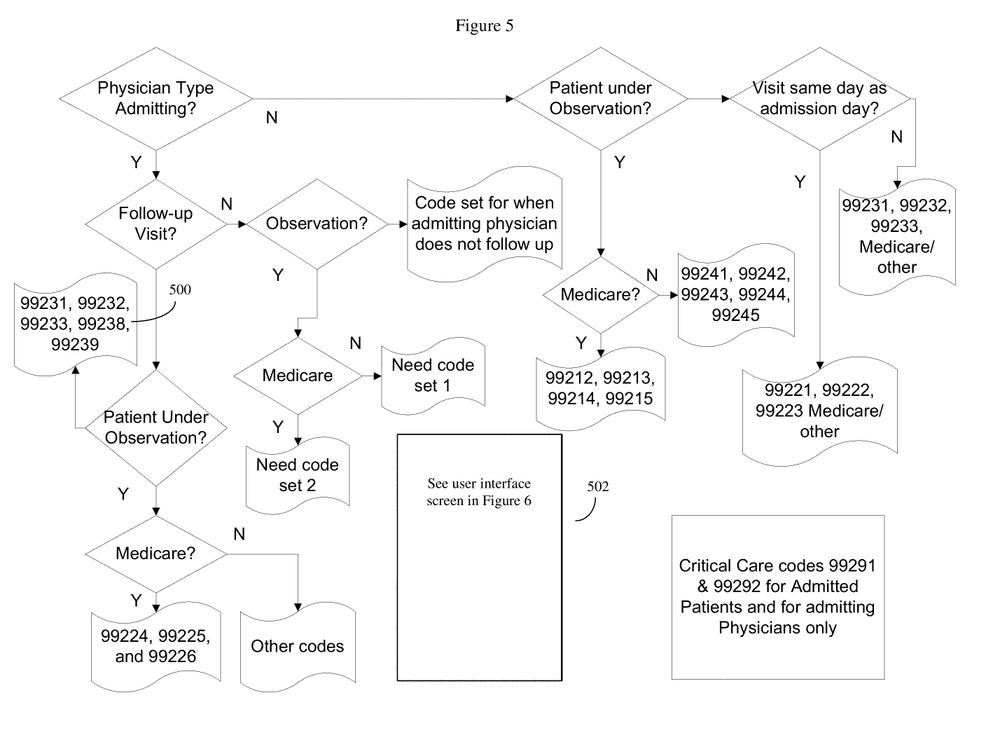

FIG. 5 shows a detail of how the system assigns CPT codes during the patient admission process to a hospital, such as implemented by admissions module (200). Again note that this process is controlled by a combination of entered data, rules appropriate to the situation, and database data such as CPT database data (210). Note that the type of insurance carrier, (e.g. Medicare or other) can have an impact on the rules that are appropriate for the situation, as well as the appropriate codes from the database (210).

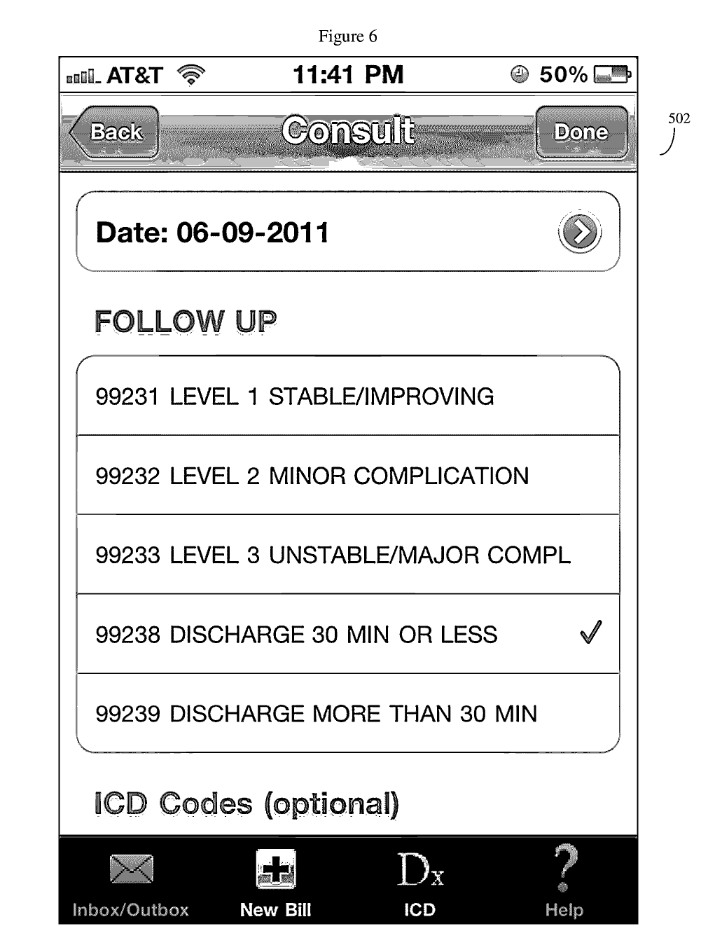

In this example, the admitting physician (114), acting as a consultant as well, has briefly admitted the patient (100) to the hospital (112) for observation. This physician is using his computerized device (104) to enter in the treatment CPT code for patient (100). This treatment code is CPT 99328 (500). The user interface screen on this device (104) is shown as (502) and in more detail in FIG. 6.

FIG. 6 shows (502) in more detail, and is a good example of the user interface that the invention may generate on a physician user's smartphone touch sensitive display screen (104). Here, as previously discussed the admitting/consultant physician (114) is entering in the appropriate CPT code (99238) for a short patient follow-up in-and-out visit where the patient will be discharged in less than 30 minutes.

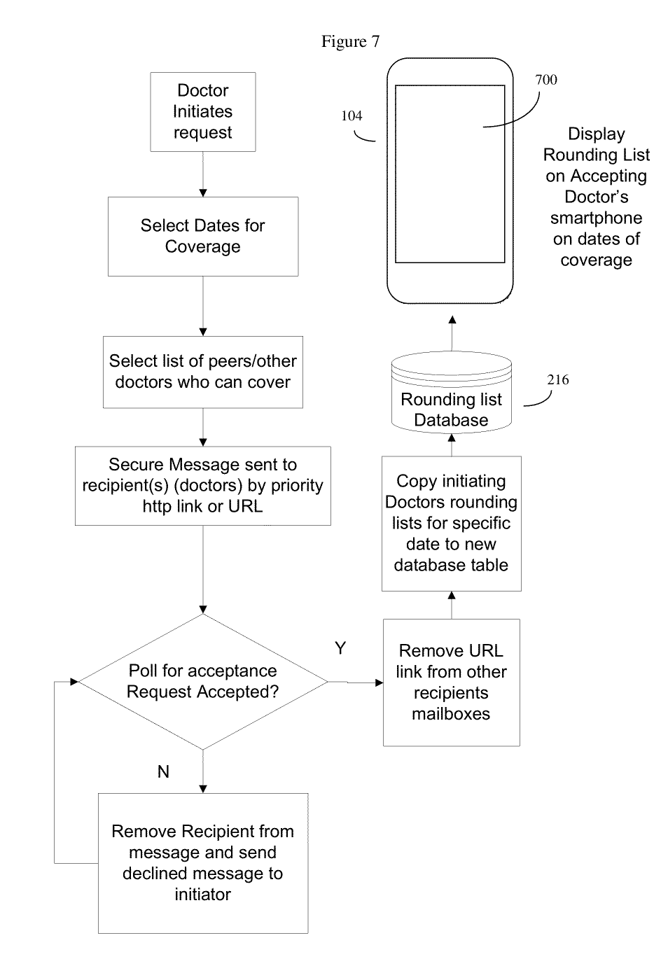

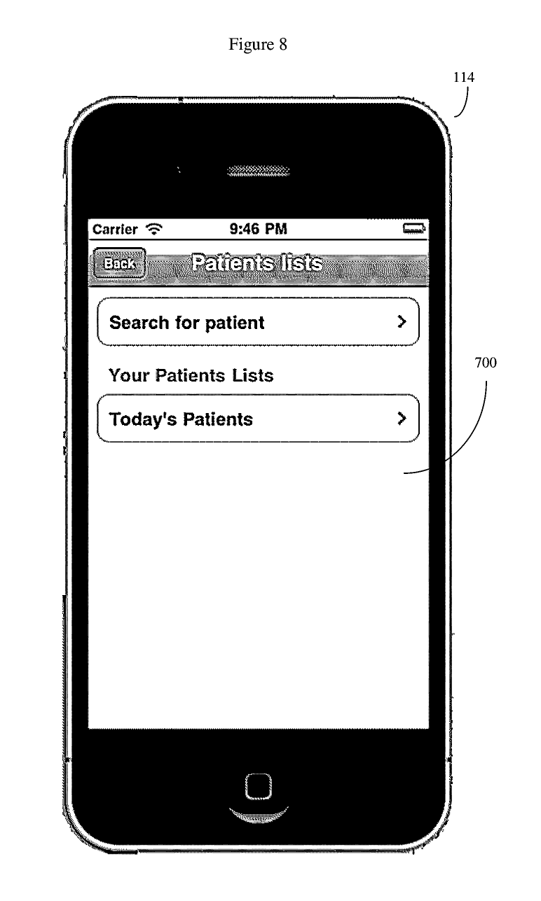

FIG. 7 shows a flow chart of some of the key steps involved in the invention's rounding list module (214). The user interface (700) for device (104) is shown in more detail in FIG. 8.

FIG. 8 shows an example of a the user interface (700) for smartphone (104) showing an example of the user interface for a particular physician's daily rounding list generated by rounding list module (214), previously discussed in FIG. 7.

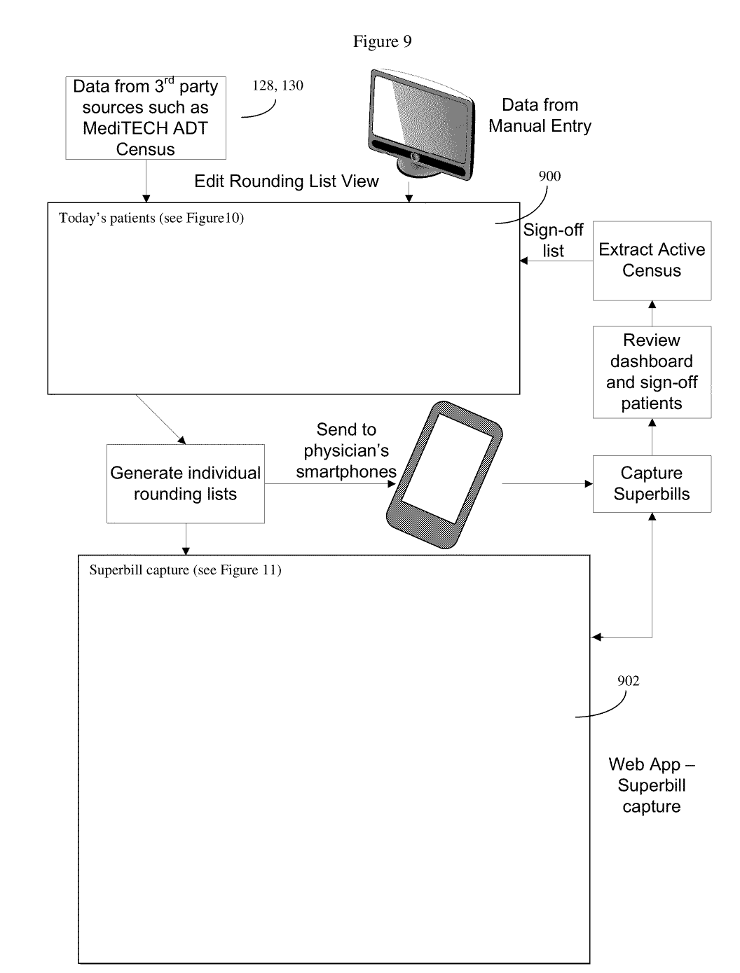

FIG. 9 shows more details of the invention's rounding list module (214) interacting with other system modules such as the superbill module (218). The modules can accept data from the hospital's database (130), or by data entry into a conventional web browser. The system can then generate rounding lists (e.g. using module 214), and send the rounding list to the relevant physician's smartphones (104) (or other mobile computerized device). The module can also capture the ICD and CPT codes entered in by the various physicians as they attend to the patient, and integrate this information into the invention's superbill module (218) as well.

FIG. 9 also shows that in addition to sending data formatted for small size (e.g. 3-5 inch diagonal) display screens on smaller devices such as smartphones, the system can optionally and additionally also send information formatted for larger size displays, such as tablet computers, portable or desktop computers, and computers running standard web browsers. In this case the system's server (106) will transmit data according to standard HTML and/or other standard web browser protocols.

FIG. 9 shows an example of a rounding list user interface screen (900) formatted for larger size display screens and standard web browsers, as well as an example of a superbill user interface screen (902) also formatted for larger size display screens and standard web browsers.

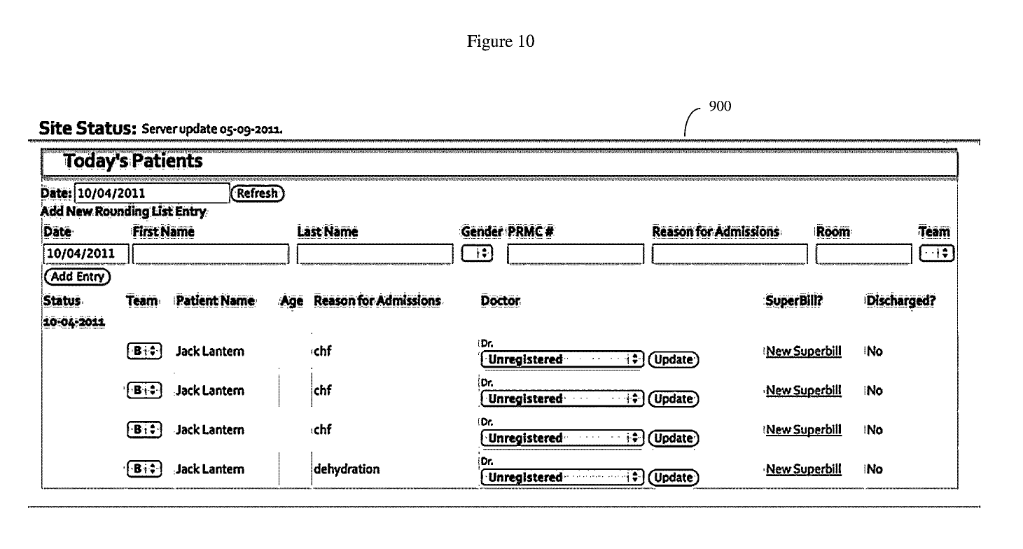

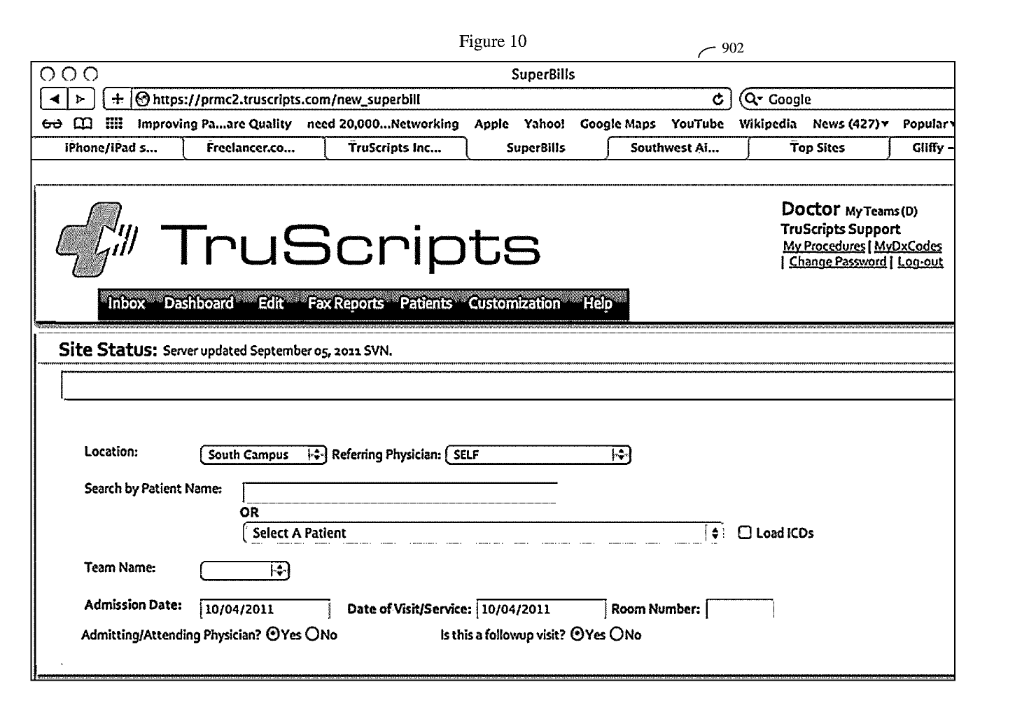

FIG. 10 shows an example of the rounding list display screen (900), here presented in higher resolution form which can be displayed in the user interface of a web browser.

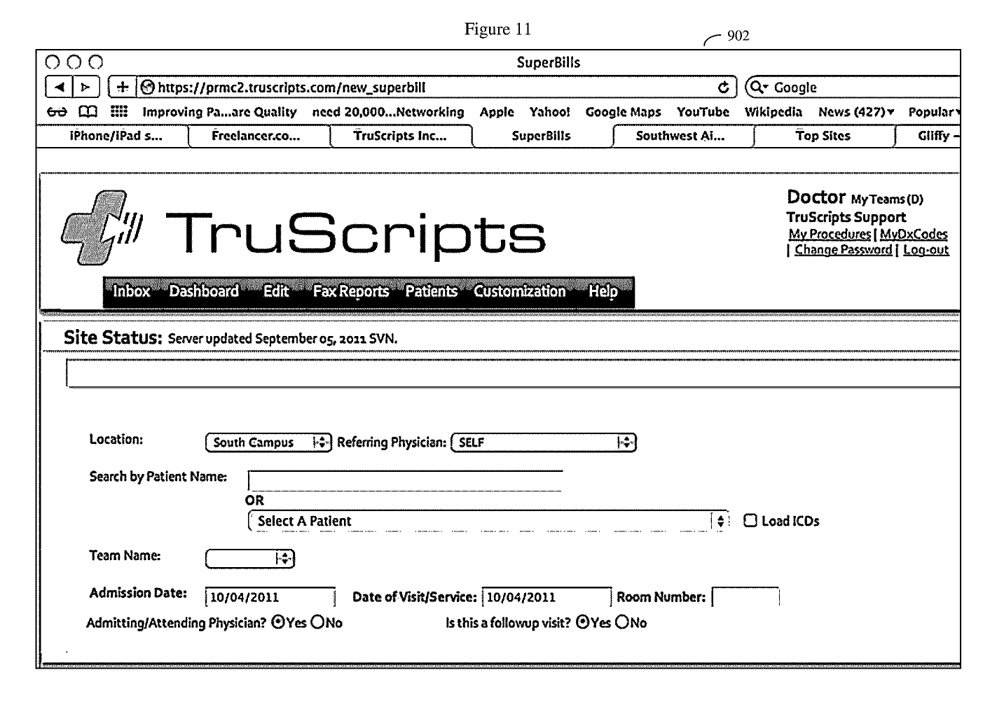

FIG. 11 shows an example of the superbill display screen (902), again presented in a higher resolution form which can be displayed in the user interface of a web browser.

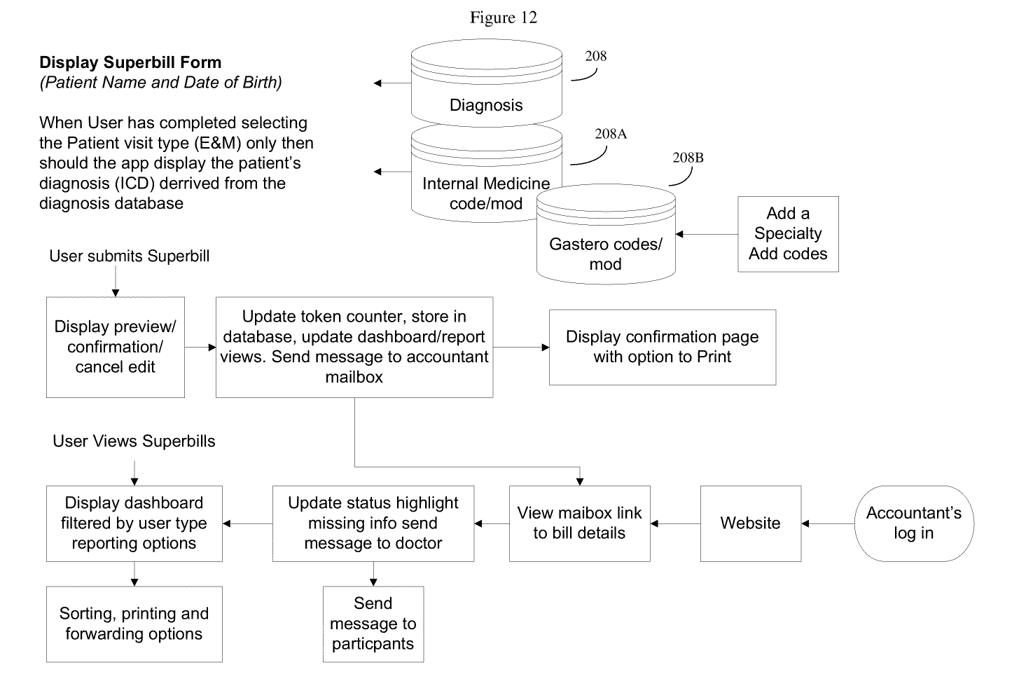

FIG. 12 shows additional detail of how the superbill module can take the patient's ICD diagnosis code from database (208), link in additional diagnosis codes for the patient as needed (208A) (208B, here a Gastroenterology diagnosis), and update and manage the corresponding patient superbill.

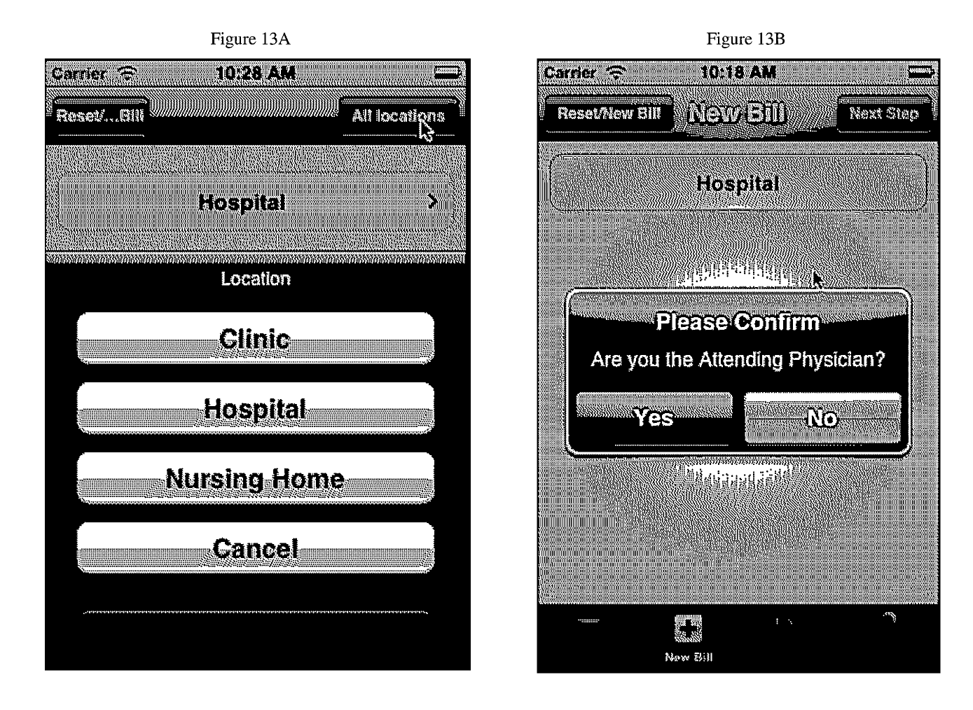

FIG. 13A shows a smartphone screenshot of device (104) that allows the HCP (114), during the new patient admission process for patient (100), to enter in the location where he or she is working. In this case this is hospital (112).

FIG. 13B shows a smartphone screenshot of device (104) that allows the HCP, during the new patient admission process, to tell the system if he or she is the attending physician or not. In small hospitals or clinics, the admitting physician (114) and the attending physician (116) may be the same person.

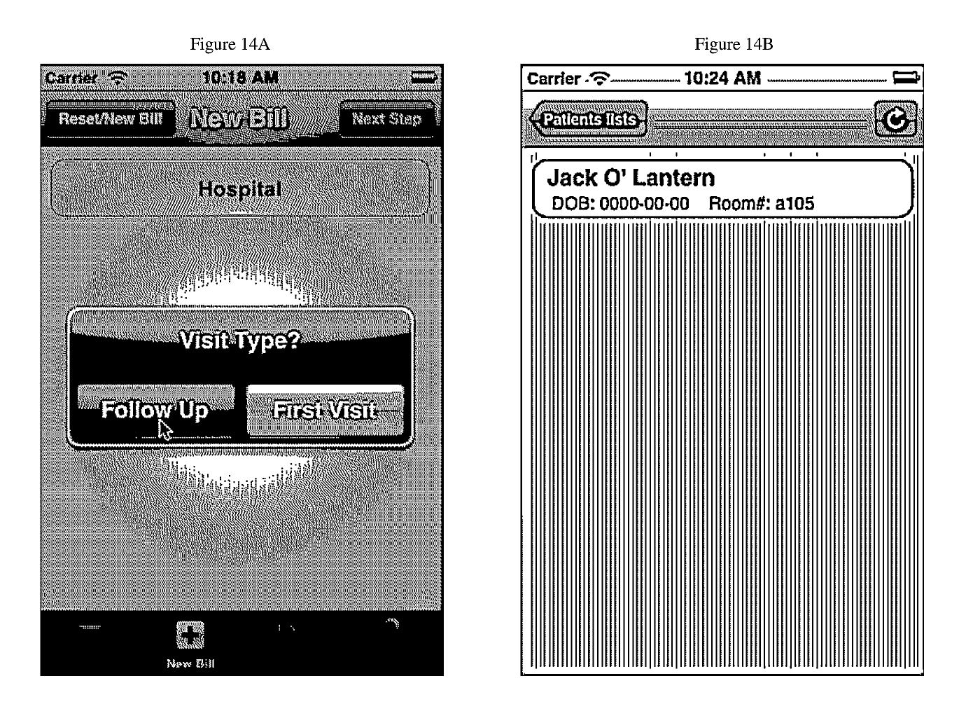

FIG. 14A shows a screenshot for a returning hospital patient (100).

FIG. 14B shows a screenshot of the system selecting a returning patient, Jack O'Lantern.

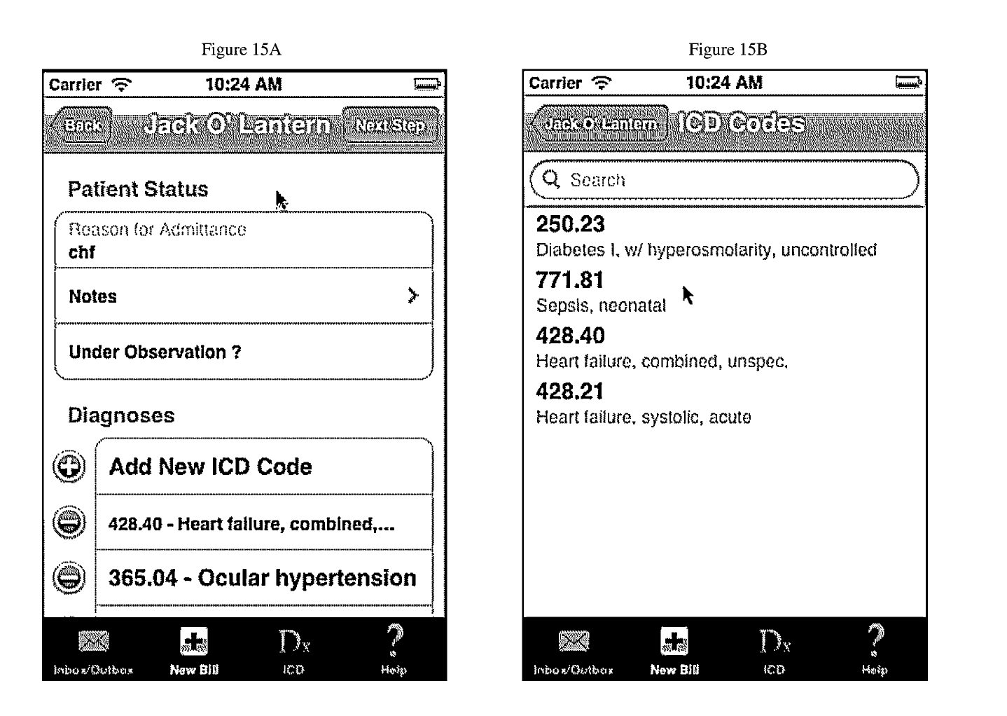

FIG. 15A shows the admitting physician (114) entering in the diagnostic reason for Jack's visit.

FIG. 15B shows the ICD codes associated with Jack's visit. These can be taken from database (208).

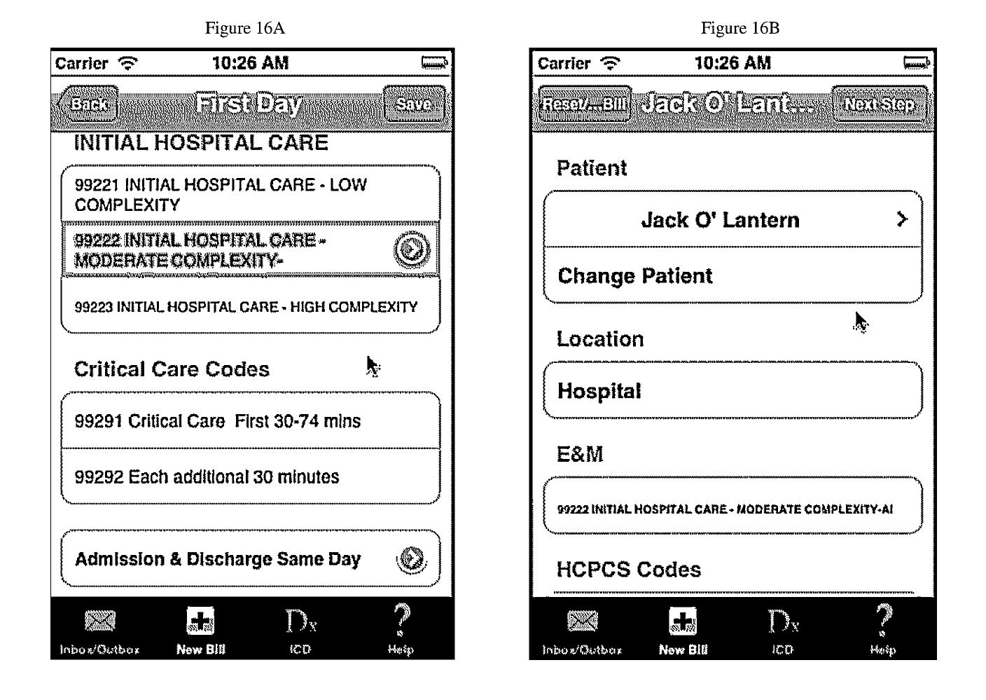

FIG. 16A shows the admitting physician (114) selecting the initial treatment CPT code for the visit. This can be taken from database (210).

FIG. 16B shows a summary of Jack's initial enrollment data.

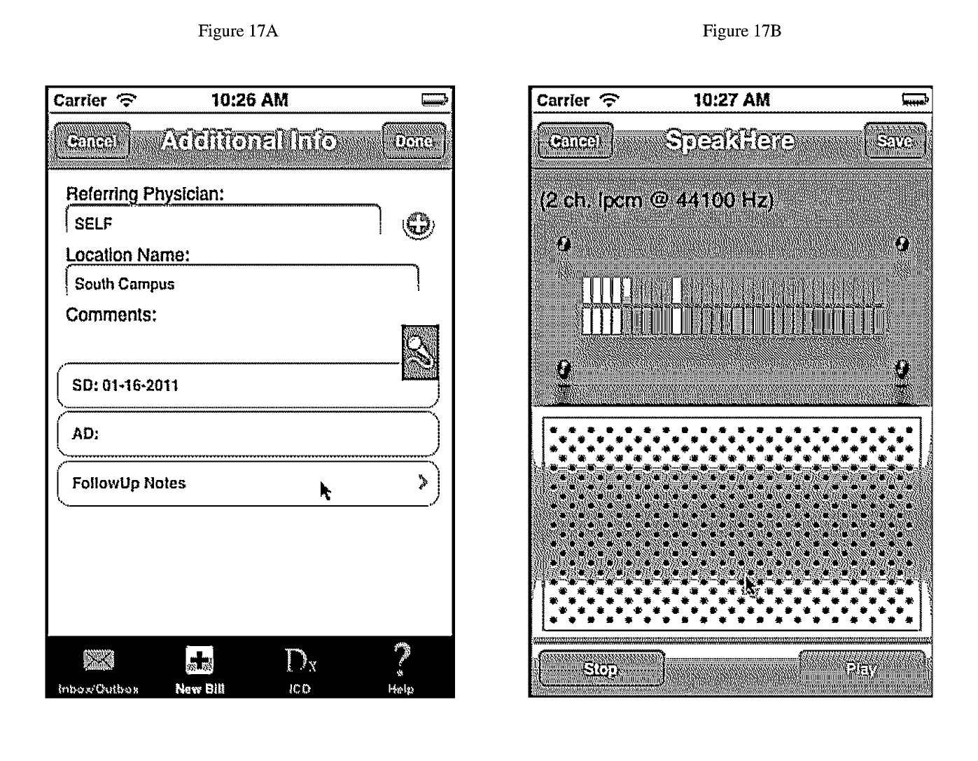

FIG. 17A shows the admitting physician (114) informing the system who the name of Jack's referring physician (or primary care physician 102) is. The name of this referring physician is “Self”, and the admitting physician can also add other notes as appropriate. Here the name of the admitting physician (114) is Scarlet O'Hara.

FIG. 17B shows that the physician or HCP can also use the device to enter in follow up notes in audio form, which can be used directly or transcribed and then used.

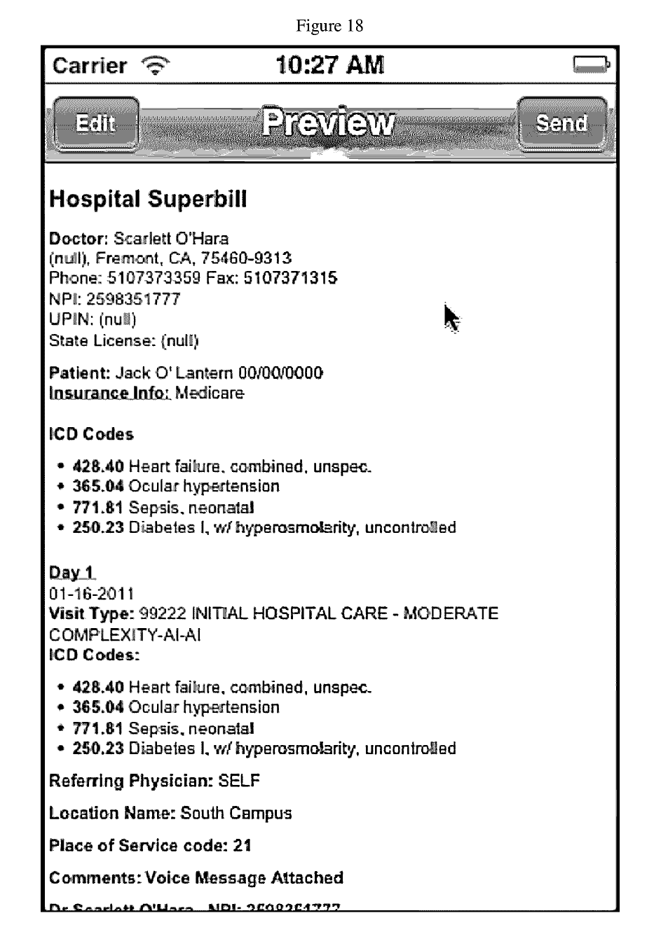

FIG. 18 shows that as the system continues to be used and various ICD code and CPT codes are entered, the system can periodically generate superbills. This superbill summarizes much of the information previously entered in by FIGS. 13A-17B, and can be generated by superbill module (218).

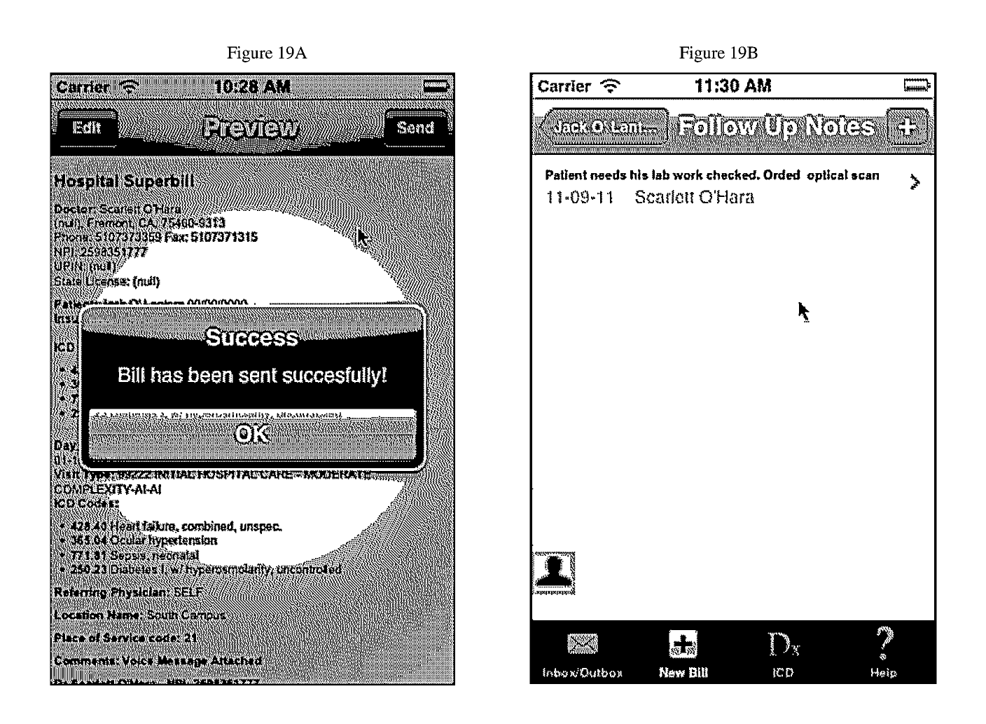

FIG. 19A shows that the admitting physician (114) has successfully transmitted this initial superbill to the appropriate administrative systems such as the legacy hospital IT system (128) and/or directly to reimbursement agencies (132), (134).

FIG. 19B shows that the admitting physician can also provide follow-up notes as needed.

As previously discussed, this process of diagnosing the patient, adding new ICD and CPT codes, can be repeated many times during the hospital or clinic stay. Eventually however, it will be time to discharge the patient.

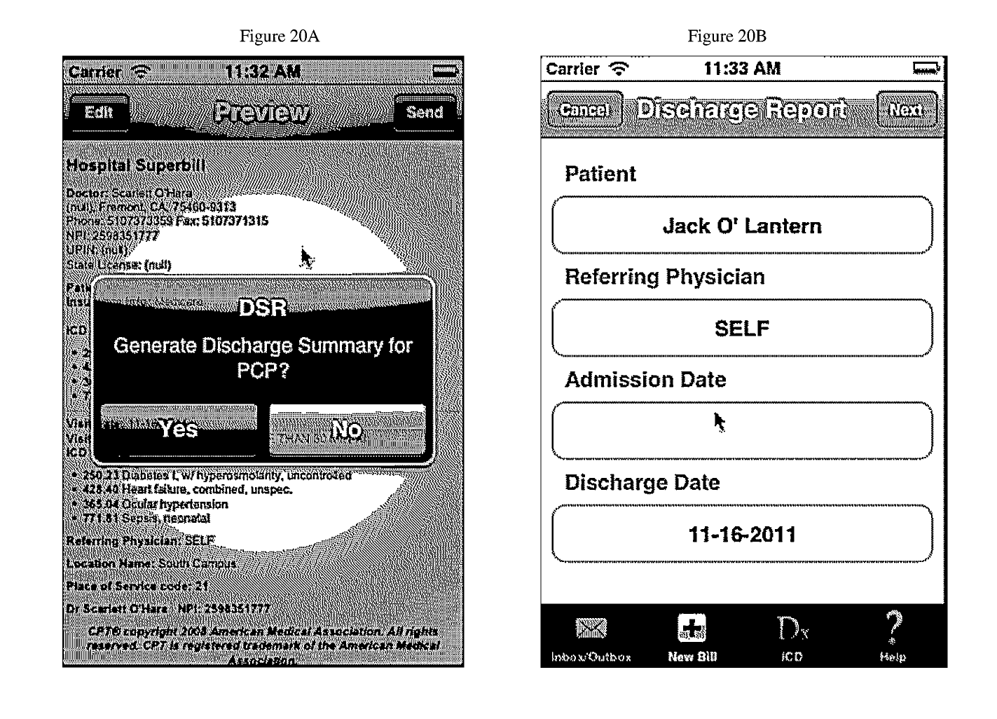

FIG. 20A shows that towards the end of the hospital stay, the system can also generate a patient discharge report, typically by using discharge software module (222).

FIG. 20B shows a process of creating the discharge report.

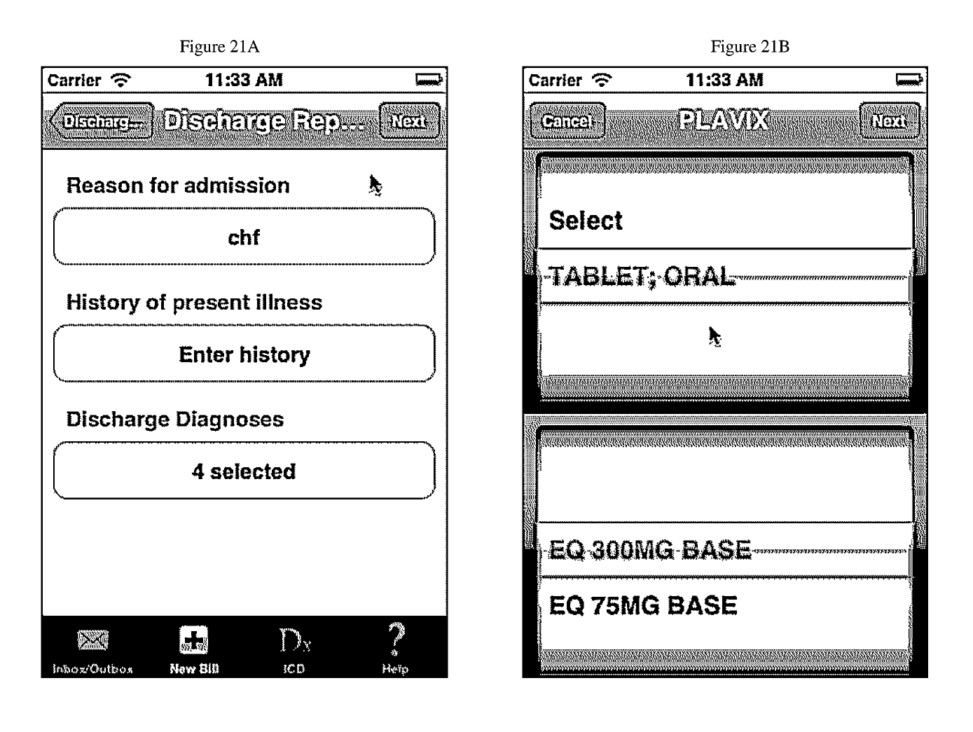

FIG. 21A shows the original reason for admission on the discharge report.

FIG. 21B shows the interface by which the attending physician (116) can order discharge medication for the patient.

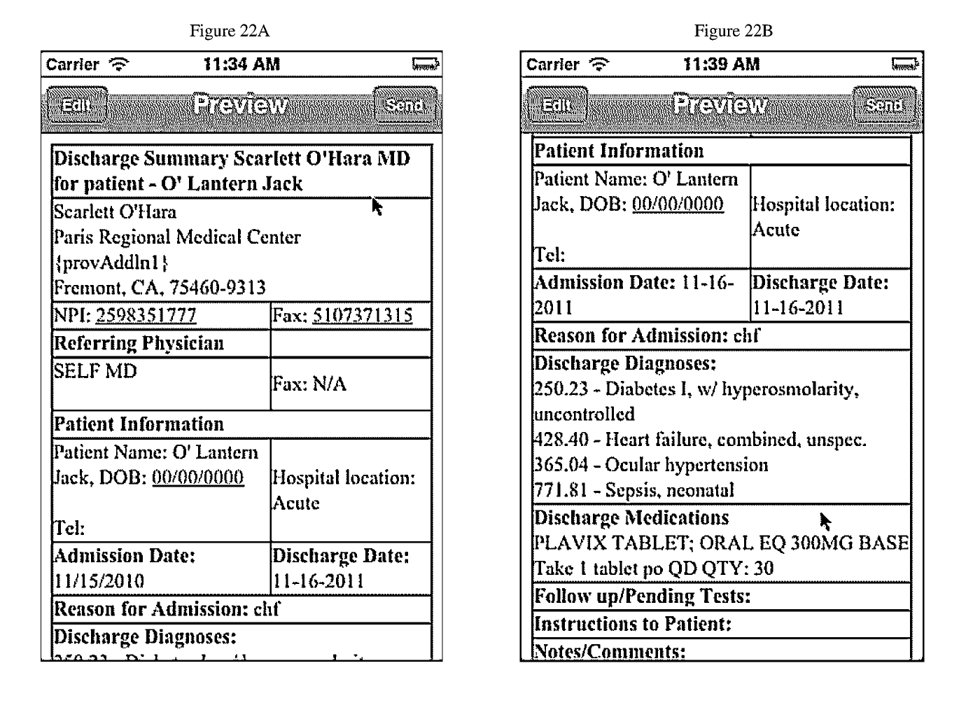

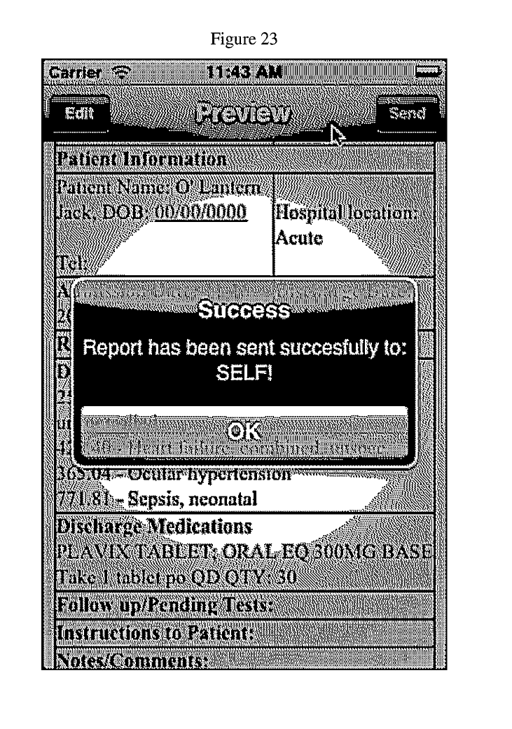

FIG. 22A shows the first part of the discharge summary for the patient.

FIG. 22B shows the second part of the discharge summary for the patient.

FIG. 23 shows that this discharge summary has been successfully transmitted to the referring physician (102) for subsequent follow up, as well as to other interested parties as appropriate.

Security and Confidentiality Considerations:

The system is generally implemented to be compliant with various Health Insurance Portability and Accountability Act (HIPPA) regulations for medical database and computerized systems, and may require passwords or other type of passcode system, voice or image identification, biometric sensors, image recognition systems and the like to ensure that access is restricted to authorized personnel. The system will function to preserve patient confidentiality within HIPPA regulations, and will, for example, generally integrate with 3^{rd} party billing systems using secure web services or other security mechanisms to help ensure confidentiality.

1. A comprehensive computerized method of health care administration by which a plurality of health care professionals (HCP) can both electronically document the fees associated with a plurality of medical treatments performed on a plurality of patients, and simultaniously manage the medical treatment of said plurality of patients;
wherein at least some of said plurality of patients are shared among at least some of said plurality of HCP in one or more health care facilities, each with health care facility identifiers;
said method comprising:
Providing a HCP database of said plurality of HCP, said HCP database comprising the HCP names, rounding schedules of said HCP, and patients assigned to said HCP during said rounding schedules;
Providing a patient database of said plurality of patients, said patient database further comprising links to said patient's medical records;
Providing an ICD database of a plurality of diagnostic ICD codes;
Providing a CPT database of a plurality of medical treatment CPT codes;
Providing a fee database based on said diagnostic ICD codes, said medical treatment CPT codes, and the medical insurance status:
Inputting information to electronically admit a patient to a health care facility, inputting type of health care facility, inputting referring HCP, inputting patient diagnostic status, and repeating the steps of:
1) inputting a patient diagnostic status, and using said ICD database to generate a diagnostic ICD code matching said patient diagnostic status, and/or
2) inputting a treatement for said patient, and using said CPT database to generate a matching medical treatment CPT code matching said patient treatment;
3) Using said HCP database and said rounding schedules of said HCP to either automatically assign said patient to one more HCP during said rounding schedules and automatically exchange information relating to said patient, or alternatively inputting data overriding said automatic assignment and automatic exchange of information and providing an alternate assignment and alternate exchange of information;
Automatically using said fee database, said diagnostic ICD code, said medical treatment CPT code, said health care facility identifier and said medical insurance status to generate at least one patient superbill, or alternatively inputting data determining when to automatically generate said at least one patient superbill;
Wherein when said patient is discharged from said health care location, inputting data to electronically transmit a patient discharge report to said referring HCP; and
Wherein said patient database, said HCP database, said ICD database, said CPT database, and fee database are stored on at least one server with wired or wireless network connectivity.

2. The method of claim 1, wherein said input is derived from the user interface provided by an application running on a handheld computerized device with wireless network connectivity and a touch screen interface, and said input is further used to annotate said patient medical records.

3. The method of claim 2, further generating one or more audio files or transcripts of audio input using said handheld computerized device, and further annotating said patient medical records with said one or more audio files or transcripts of audio input, and/or transmitting said audio files or transcripts of audio input to one or more HCP according to said HCP rounding schedules.

4. The method of claim 2, wherein at least a copy of portions of said patient database, HCP database, ICD database, CPT database and said fee database reside in the memory of said handheld computerized device with wireless network connectivity and a touch screen interface, and said at least a copy is periodically updated from said server using said wireless network connectivity.

5. The method of claim 1, wherein said input is derived from the user interface of a web browser running on a computerized device, said computerized device is connected by said server by said wired or wireless network, said input is further used to annotate said patient medical records.

6. The method of claim 1, wherein said superbill comprises provider information, physician information, patient information, visit information, said diagnostic ICD codes, said medical treatment CPT codes, date of service, time of service location, units of service, and drug quantity.

7. The method of claim 1, further electronically transmitting a patient admission summary report to said referring HCP at time of patient admission.

8. The method of claim 1, wherein said discharge summary comprises, for the duration of said patients hospital stay a record of: main diagnoses, surgeries or procedures, diagnostic tests, consultant list, summary of complications, list of medications on discharge, list of pending lab test, a list of recommended tests, patient condition on discharge, patient instructions, and physician instructions.

9. The method of claim 1, wherein said HCP comprise admitting physicians, attending physicians, referring physician, primary care physicians, emergency room physicians, nurses, and therapists.

10. The method of claim 1, further generating a rounding list for said HCP comprising a list of patients assigned to said HCP during at least said HCP's current rounding list shift, location of said patient, and said patient diagnostic status, and using said rounding list as an index to retrieve at least portions of said patient's medical records.

11. The method of claim 10, wherein if a HCP desires to request cover or backup by another HCP on certain dates, said rounding lists are automatically shared and updated to reflect said cover or backup by said another HCP on said certain dates.

12. The method of claim 1, wherein said handheld computerized device is a smartphone.

13. The method of claim 1, further generating census reports with summary statistics and/or charts showing overall utilization of said health care facility during a selected period of time.

14. A comprehensive computerized method of health care administration by which a plurality of health care professionals (HCP) can both electronically document the fees associated with a plurality of medical treatments performed on a plurality of patients, and simultaniously manage the medical treatment of said plurality of patients;
wherein at least some of said plurality of patients are shared among at least some of said plurality of HCP in one or more health care facilities, each with health care facility identifiers;
said method comprising:
Providing a HCP database of said plurality of HCP, said HCP database comprising the HCP names, rounding schedules of said HCP, and patients assigned to said HCP during said rounding schedules;
Providing a patient database of said plurality of patients, said patient database further comprising links to said patient's medical records;
Providing an ICD database of a plurality of diagnostic ICD codes;
Providing a CPT database of a plurality of medical treatment CPT codes;
Providing a fee database based on said diagnostic ICD codes, said medical treatment CPT codes, and the medical insurance status:
Inputting information to electronically admit a patient to a health care facility, inputting type of health care facility, inputting referring HCP, inputting patient diagnostic status, and repeating the steps of:
1) inputting a patient diagnostic status, and using said ICD database to generate a diagnostic ICD code matching said patient diagnostic status, and/or 2) inputting a treatement for said patient, and using said CPT database to generate a matching medical treatment CPT code matching said patient treatment;
3) Using said HCP database and said rounding schedules of said HCP to either automatically assign said patient to one more HCP during said rounding schedules and automatically exchange information relating to said patient, or alternatively inputting data overriding said automatic assignment and automatic exchange of information and providing an alternate assignment and alternate exchange of information;
Automatically using said fee database, said diagnostic ICD code, said medical treatment CPT code, said health care facility identifier and said medical insurance status to generate at least one patient superbill, or alternatively inputting data determining when to automatically generate said at least one patient superbill;
wherein said superbill comprises provider information, physician information, patient information, visit information, said diagnostic ICD codes, said medical treatment CPT codes, date of service, time of service location, units of service, and drug quantity;
Wherein when said patient is discharged from said health care location, inputting data to electronically transmit a patient discharge report to said referring HCP;
wherein said patient discharge report is electronically transmitted by electronic messaging or by fax;
Wherein said patient database, said HCP database, said ICD database, said CPT database, and fee database are stored on at least one server with wired or wireless network connectivity;
Wherein input from at least some HCP for at least some patients is derived from the user interface provided by an application running on a smartphone or other handheld computerized device with wireless network connectivity and a touch screen interface, and said input is further used to annotate said patient medical records; and
wherein at least a copy of portions of said patient database, HCP database, ICD database, CPT database and said fee database reside in the memory of said handheld computerized device, and said at least a copy is periodically updated from said server using said wireless network.

15. The method of claim 14, further generating one or more audio files or transcripts of audio input using said handheld computerized device, and further annotating said patient medical records with said one or more audio files or transcripts of audio input, and/or transmitting said audio files or transcripts of audio input to one or more HCP according to said HCP rounding schedules.

16. The method of claim 14, wherein input from at least some HCP for at least some patients is is also derived from the user interface of a web browser running on a computerized device, said computerized device is connected by said server by said wired or wireless network, said input is further used to annotate said patient medical records.

17. The method of claim 14, further electronically transmitting a patient admission summary report to said referring HCP at time of patient admission.

18. The method of claim 14, wherein said discharge summary comprises, for the duration of said patients hospital stay a record of: main diagnoses, surgeries or procedures, diagnostic tests, consultant list, summary of complications, list of medications on discharge, list of pending lab test, a list of recommended tests, patient condition on discharge, patient instructions, and physician instructions.

19. The method of claim 14, wherein said HCP comprise admitting physicians, attending physicians, referring physician, primary care physicians, emergency room physicians, nurses, and therapists.

20. The method of claim 14, further generating a rounding list for said HCP comprising a list of patients assigned to said HCP during at least said HCP's current rounding list shift, location of said patient, and said patient diagnostic status, and using said rounding list as an index to retrieve at least portions of said patient's medical records.

21. The method of claim 14, further generating census reports with summary statistics and/or charts showing overall utilization of said health care facility during a selected period of time.
